(19) United States
(12) Patent Application Publication
(10) Pub. No.: US 2016/0117144 A1
(43) Pub. Date: Apr. 28, 2016

(54) COLLABORATIVE AND INTERACTIVE QUEUING OF CONTENT VIA ELECTRONIC MESSAGING AND BASED ON ATTRIBUTE DATA

(71) Applicants: Austin Soldner, Keller, TX (US); Jonathan Todd Witort, Berkeley, CA (US); Mehul Trivedi, San Francisco, CA (US); Vivek Agrawal, San Francisco, CA (US)

(72) Inventors: Austin Soldner, Keller, TX (US); Jonathan Todd Witort, Berkeley, CA (US); Mehul Trivedi, San Francisco, CA (US); Vivek Agrawal, San Francisco, CA (US)

(73) Assignee: AliphCom, San Francisco, CA (US)

(21) Appl. No.: 14/920,697

(22) Filed: Oct. 22, 2015

Related U.S. Application Data
(60) Provisional application No. 62/067,428, filed on Oct. 22, 2014.

(51) Int. Cl. G06F 3/16; H04L 29/08

(52) U.S. Cl. CPC G06F 3/165; H04L 67/306

(57) ABSTRACT

An application (APP) executing in a processor of a host device, may receive an electronic message (EM) that may include a handle for an address associated with the host device or a user of the host device, and a data payload that identifies content to be played back on a media device in communication (e.g., wirelessly) with the host device. An electronic messaging service may receive EM's addressed to the handle and may broadcast (e.g., wirelessly) the EM's. EM's received by the host device may be parsed by the APP to extract the handle and data payload. Data in the data payload may be used to search a content source for content to be communicated (e.g., wirelessly) for playback on the media device. Content specified in data payloads of EM's from one or more client devices (e.g., smartphones, tablets, pads) may be queued for playback on the media device.

### RELATED APPLICATIONS

This application claims the benefit of U.S. Provisional Patent Application No. 62/067,428 filed Oct. 22, 2014 with Attorney Docket No. ALI-034P, which is herein incorporated by reference.

### FIELD

Embodiments of the present application relate generally to electrical and electronic hardware, computer software, application programming interfaces (APIs), wired and wireless communications, Bluetooth systems, RF systems, wireless media devices, portable personal wireless devices, and consumer electronic (CE) devices.

### BACKGROUND

As wireless media devices that may be used to playback content such as audio (e.g., music) and/or video (e.g., movies, YouTube™, etc.) become more prevalent, an owner of such a media device may wish to share its playback capabilities with guests, friends or other persons. In some conventional applications, each wireless media device may require a pairing (e.g., Bluetooth pairing) or access credentials (e.g., a login, a user name/email address, a password) in order for a client device (e.g., a smartphone, a table, a pad, etc.) to gain access to the wireless media device (e.g., WiFi and/or Bluetooth enabled speaker boxes and the like). In some wireless media devices, there may be a limit to the number of client devices that may be paired with the media device (e.g., from 1 to 3 pairings). An owner may not wish to allow guests or others to have access credentials to a network (e.g., a WiFi network) that the media device is linked with and/or may not wish to allow guest to pair with the media device.

In a social environment, an owner may wish to provide guests or others with some utility of the media device (e.g., playback of guest content) without having to hassle with pairing each client device with the media device or having to provide access credentials to each client device user.

Accordingly, there is a need for systems, apparatus and methods that provide content handling that overcomes the drawbacks of the conventional approaches.

### BRIEF DESCRIPTION OF THE DRAWINGS

Various embodiments or examples (“examples”) are disclosed in the following detailed description and the accompanying drawings:

FIG. 1 depicts one example of a flow diagram of playback of content using electronic messaging;

FIG. 2 depicts one example of a computer system;

FIG. 3 depicts one example of a system to playback content using electronic messaging;

FIG. 4 depicts another example of a system to playback content using electronic messaging;

FIG. 5 depicts yet another example of a system to playback content using electronic messaging; and

FIG. 6 depicts an example of playback of content using electronic messaging;

FIG. 7 is a diagram depicting an example of a collaborative playback manager, according to some embodiments;

FIG. 8 is a diagram depicting one example of operation of a collaborative playback manager, according to some examples;

FIG. 9 is a diagram depicting another example of operation of a collaborative playback manager, according to some examples;

FIG. 10 is an example of a flow diagram to modify a sequence of content stored in a queue to adjust a collaborative playlist, according to some embodiments;

FIGS. 11A and 11B are diagrams depicting implementation of a user interface controller, according to various embodiments; and

FIG. 12 illustrates an exemplary computing platform disposed in a device configured to adjust collaborative playlists via electronic messaging in accordance with various embodiments.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including but not limited to implementation as a system, a process, a method, an apparatus, a user interface, or a series of executable program instructions included on a non-transitory computer readable medium. Such as a non-transitory computer readable medium or a computer network where the program instructions are sent over optical, electronic, or wireless communication links and stored or otherwise fixed in a non-transitory computer readable medium. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

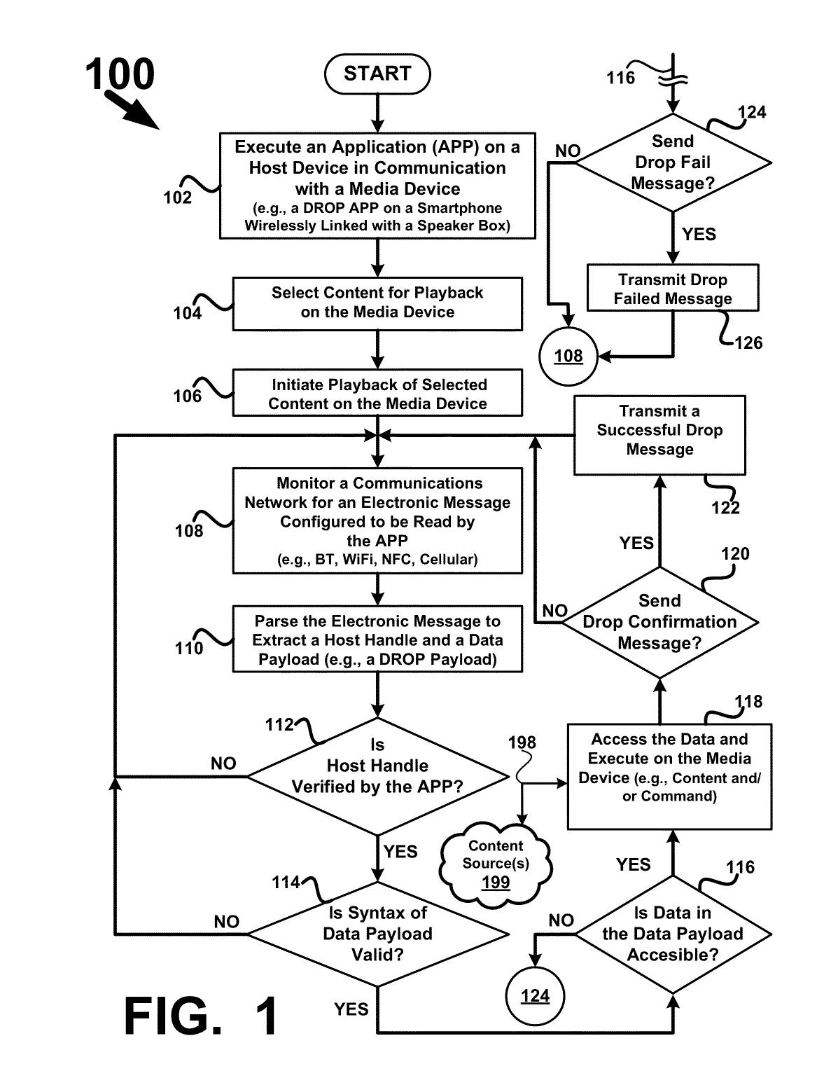

Reference is now made to FIG. 1 where one example of a flow diagram 100 of playback of content using electronic messaging is depicted. At a stage 102 an application (e.g., an APP), such as the type that may be installed or otherwise downloaded on an electronic device such as a smartphone, smart watch, wearable device, tablet, pad, tablet PC, laptop, PC, server, or other devices, may be executed (e.g., opened, started up, booted up, etc.) on a host device that may be in communication with a media device. Examples of media devices include but are not limited to wired and/or wirelessly enabled speaker boxes, audio and/or video playback devices, headphones, headsets, earpieces, audio-video systems, stereo systems, computing systems (e.g., desktop PC, laptops), media systems, media servers, in-home entertainment systems, portable audio and/or video devices, just to name a few. In some examples the APP may be a DROP APP operative to receive and parse an electronic message that has been transmitted (e.g., has been dropped) to an addressed associated with the host device (e.g., an electronic messaging account address of a user of the hose device, such as email account or a Twitter account) as is described below.

If the host device is not in communication with the media device at the time the APP is executing, then the media device and/or host device may be activated or otherwise made to establish a wireless and/or wired communications link with each other, either directly as in the case of a Bluetooth (BT) pairing, for example, or indirectly, as in the case of using a wireless access point, such as a WiFi wireless router, for example. At a stage 104 content (e.g., from a playlist, file, directory, a data store, a library, etc.) may be selected for playback on the media device. The content may include without limitation, various forms of media or information that may be accessible by an electronic device, such as music, video, movies, text, electronic messages, data, audio, images (moving or still), digital files, compressed files, uncompressed files, encrypted files, just to name a few. In the discussion that follows, music (e.g., songs/music/voice/audio/soundtracks/performances in a digital format—MP3, FLAC, PCM, DSD, WAV, MPEG, ATRAC, AAC, RIFF, WMA, lossless compression formats, lossy compression formats, etc.) may be used as one non-limiting example of what may include content.

The content to be selected (e.g., using the APP) may be presented on an interface (e.g., display, touchscreen, GUI, menu, dashboard, etc.) of the host device and/or the media device. A cursor, finger, stylus, mouse, touchpad, voice command, bodily gesture recognition, eye movement tracking, keyboard, or other type of user interface may be used to select the content for playback on the media device. The content may reside in a data store (e.g., non-volatile memory) that is internal to the host device, external to the host device, internal to the media device, external to the media device, for example. The content may reside in one or more content sources 199, such as Cloud storage, the Cloud, the Internet, network attached storage (NAS), RAID storage, a content subscription service, a music subscription service, a streaming service, a music service, or the like (e.g., iTunes, Spotify, Rdio, Beats Music, YouTube, Amazon, Rhapsody, Xbox Music Pass, Deezer, Sony Music Unlimited, Google Play Music All Access, Pandora, Slacker Radio, SoundCloud, Napster, Grooveshark, etc.).

At a stage 106 playback of the content selected at the stage 104 may be initiated on the media device. Initiation of playback at the stage 106 may include playback upon selection of the content or may include queuing the selected content for later playback in a queue order (e.g., there may be other content in the queue that is ahead of the selected content). For purposes of explanation, assume the selected content may include music from a digital audio file. At the stage 106, initiating playback may include the media device accessing (internally or externally) the digital audio file and streaming or downloading the digital audio file for playback hardware and/or software systems of the media device.

At a stage 108 a communications network (e.g., wired and/or wireless) may be monitored for an electronic message from another device (e.g., a wireless client device, smartphone, cellular phone, tablet, pad, laptop, PC, smart watch, wearable device, etc.). The electronic message may be transmitted by a client device and received by the host device, the APP may act on data in the message (e.g., via an API with another application on the host device) to perform some task for the sender of the electronic message (e.g., a user of the client device). The communications network may include without limitation, a cellular network (e.g., 2G, 3G, 4G, etc.), a satellite network, a WiFi network (e.g., one or more varieties of IEEE 802.x), a Bluetooth network (e.g., BT, BT low energy), a NFC network, a WiMAX network, a low power radio network, a software defined radio network, a HackRF network, a LAN network, just to name a few, for example. Here, one or more radios in the host device and/or media device may monitor the communications network for the electronic message configured to Drop on the APP (e.g., data and/or data packets in a RF signal that may be read, interpreted, and acted on by the APP).

At as stage 110, the electronic message, received by the host device and/or media device (e.g., by a radio), may be parsed (e.g., by a processor executing the APP) to extract a host handle (e.g., an address that correctly identifies the host device upon which the APP is executing) and a Data Payload (e.g., a data payload included in the electronic message, such as a packet that includes a data payload). The electronic message may have a format determined by a protocol or communication standard, for example. The electronic message may include without limitation an email, a text message, a SMS, a Tweet, an instant message (IM), a SMTP message, a page, a one-to-one communication, a one-to-many communication, a social network communication (e.g., Facebook, Twitter, Flickr, Pinterest, Tumblr, Yelp, etc.), a professional/business network communication, an Internet communication, a blog communication (e.g., LinkedIn, HR.com, etc.), a bulletin board communication, a newsgroup communication, a Usenet communication, just to name a few, for example. In that there may be a variety of different types of electronic messages that may be received, the following examples describe a Tweet (e.g., from a Twitter account) as one non-limiting examples of types of electronic message that may be dropped on the APP. The electronic message may be formatted in packets or some other format, where for example, a header field may include the host handle and a data field may include a data payload (e.g., a DROP Payload). As is described below, the data payload that is dropped via the electronic message may include an identifier for content to be played back on the media device (e.g., a song title, an artist or band/group name, an album title, a genera of music or other form of performance, etc.), a command (e.g., play a song, volume up or down, bass up or down, or skip current track being played back, etc.), or both.

At a stage 112 a determination may be made as to whether or not the host handle is verified by the APP. For example, the received electronic message (e.g., a Tweet) may have been addressed to Twitter handle “@SpeakerBoxJoe”. If a Twitter account associated with the APP is for account “SpeakerBoxJoe@twitter.com”, then the APP may recognize that the host handle “@SpeakerBoxJoe” matches the account for “SpeakerBoxJoe@twitter.com”. Therefore, if the host handle in the electronic message is a match, then a YES branch may be taken from the stage 112 to a stage 114. On the other hand, if the host handle in the electronic message does not match (e.g., the handle in the electronic message is “@SpeakerBoxJill”), then a NO branch may be taken from the stage 112 to another stage in flow 100, such as back to the stage 108 where continued monitoring of the communications network may be used by the APP to wait to receive valid electronic messages (e.g., a Tweet that includes a correct Twitter handle “@SpeakerBoxJoe”).

At the stage 114 a determination may be made as to whether or not a syntax of the data payload is valid. A correct grammar for datum that may be included in the data payload may be application dependent; however, the following include non-limiting examples of valid syntax the APP may be configured to act on. As a first example, the data payload may include a song title that the sender of the electronic message would like to be played back on or queued for playback on the media device. To that end, the electronic message may include the host handle and the data payload for the title of the song, such as: (a) “@SpeakerBoxJoe play rumors”; (b) “@SpeakerBoxJoe rumors”; or (c) “@SpeakerBoxJoe #rumors”. In example (a), the data payload may include the word “play” and the title of the requested song “rumors”, with the host handle and the words play and rumors all separated by at least one blank space “ ”. In example (b), the data payload may include the title of the requested song “rumors” separated from the host handle by at least one black space “ ”. In example (c), the data payload may include a non-alphanumeric character (e.g., a special character from the ASCII character set) that may immediately proceed the text for the requested song, such as a “#” character (e.g., a hash tag) such that the correct syntax for a requested song is “(hash-tag)(song-title) with no blank spaces between. Therefore the correct syntax to request the song “rumors” is “#rumors” with at least one black space “ ” separating the host handle and the requested song. In the examples (a)-(c), the syntax for one or more of the host handle, the requested content, or the requested command, may or may not be case sensitive. For example, all lower case, all upper case, or mixed upper and lower case may be acceptable. Although non-limiting examples (a)-(c) had a song title as the data payload, other datum may be included in the data payload such as the aforementioned artist name, group name, band name, orchestra name, and commands.

As one example of a non-valid syntax for a data payload, if the hash tag “#” is required immediately prior to the song title, and the electronic message includes “@SpeakerBoxJoe $happy”, the “$” character before the song title “happy” would be an invalid syntax. As another example, “@SpeakerBoxJoe plays happy”, would be another invalid syntax because “play” and not “plays” must precede the song title. A host handle may be rejected as invalid due to improper syntax, such as “SpeakerBoxJoe $happy”, because the “@” symbol is missing in the host handle.

If a NO branch is taken from the stage 114, then flow 100 may transition to another stage, such as back to the stage 108 where continued monitoring of the communications network may be used by the APP to wait to receive valid electronic messages (e.g., electronic messages with valid syntax). If a YES branch is taken from the stage 114, then flow 100 may transition to a stage 116.

At the stage 116 a determination may be made as to whether or not data specified in the data payload is accessible. For example, the data specified in the data payload may include content (e.g., a digital audio file for the song “happy”). That content may reside in one or more data stores that may be internal or external to the host device, the media device or both. The data is accessible if it may be electronically accessed (e.g., using a communications network or link) from the location where it resides (e.g., the Cloud, a music/content streaming service, a subscription service, hard disc drive (HDD), solid state drive (SSD), Flash Memory, NAS, RAID, etc.). Data may not be accessible even though the data store(s) are electronically accessible because the requested content does not reside in the data store(s). For example, at the stage 116, the APP may perform a search of the data store(s) (e.g., using an API) for a song having the title “happy”. The search may return with a NULL result if no match is found for the song “happy”.

If the data in the data payload is not accessible (e.g., due to no match found or inability to access the data store(s)), then a NO branch may be taken from the stage 116 to another stage in flow 100, such as an optional stage 124 where a determination may be as to whether or not to transmit an electronic message (e.g., to the host device and/or the device that transmitted the request) that indicates that the Drop failed. If a YES branch is taken from the stage 124, then a failed Drop message may be transmitted at a stage 126. Stage 126 may transition to another stage of flow 100, such as back to stage 108 to monitor communications for other electronic messages, for example. If a NO branch is taken from the stage 124, then stage 124 may transition to another stage of flow 100, such as to stage 108 to monitor communications for other electronic messages.

If the data in the data payload is accessible, then a YES branch may be taken from the stage 116 to a stage 118 where the data in the data payload is accessed and may be executed on the media device. Execution on the media device may include playback of content such as audio, video, audio and video, or image files that include the data that was accessed. In some example, the data may include a command (e.g., #pause to pause playback, #bass-up to boost bass output, #bass-down to reduce bass output, etc.) and data for the command may be accessed from a data store in the host device, the media device or both (e.g., ROM, RAM, Flash Memory, HDD, SSD, or other).

In some examples, the data may be external to the host device, the media device, or both and may be accessed 198 from a content source 199 (e.g., the Cloud, Cloud storage, the Internet, a web site, a music service or subscription, a streaming service, a library, a store, etc.). Access 198 may include wired and/or wireless data communications as described above.

The stage 118 may transition to another stage in flow 100, such as optional stage 120 where a determination may be made as to whether or not to send a Drop confirmation message. If a NO branch is taken, then flow 100 may transition to another stage such as the stage 108 where communications may be monitored for other electronic messages. Conversely, if a YES branch is taken from the stage 120, then flow 100 may transition to a stage 122 where a successful drop message may be transmitted (e.g., to the host device and/or the device that transmitted the request). Stage 122 may transition to another stage in flow 100 such as the stage 108 where communications may be monitored for other electronic messages. A successful drop message may include an electronic message, for example “@SpeakerBoxJoe” just Dropped rumors”.

Successful electronic messages (e.g., at stage 122) may be transmitted to the host device, a client device that sent the initial electronic message or both. As one example, an electronic message transmitted in the form of a “Tweet” may be replied to as an electronic message in the form of another “Tweet” to the address (e.g., handle) of the sender. For example, if “@PartyGirlJane” tweeted electronic message “@SpeakerBoxJoe #seven nation army”, and that song was successfully dropped, then at the stage 122 an electronic message to the sender “@PartyGirlJane” may include “@SpeakerBoxJoe just Dropped seven nation army”. In some examples, failure of an electronic message may be communicated to a client device, a host device or both (e.g., at the stage 126). As one example, if at the stage 116 is it determined that the data for “seven nation army” is not accessible (e.g., the song is not available as a title/file in the content source(s) 198), then at the stage 126 an electronic message to the sender “@PartyGirlJane” may include “@SpeakerBoxJoe failed to Drop seven nation army”.

Different communications networks may be used at different stages of flow 100. For example, communications between the host device and the media device may be via a first communications network (e.g., BT), communication of the electronic message at the stage 108, the drop confirmation message at the stage 122, and or drop failed message as the stage 126 may be via a second communications network (e.g., a cellular network), and accessing the data at the stage 118 may be via third communications network (e.g., WiFi). In some examples, drop confirmation at stage 122 (or any portions of the flow) can include a signature audio snippet (e.g., 2 seconds or less) or a sound, such as an explosion sound. As such, listeners can auditorily identify the identity of the requester of a song. The signature audio snippet can be uniquely identify a specific requester that requested a song as it begins playing or is presented (e.g., “is dropped”) at a media device or any other audio presentation device. In some instances, data representing the signature audio snippet can be stored a networked server system that can be transmitted to any destination account, such as any Twitter™ handle or other unique user identifier data (e.g., identifying a user's electronic messaging account).

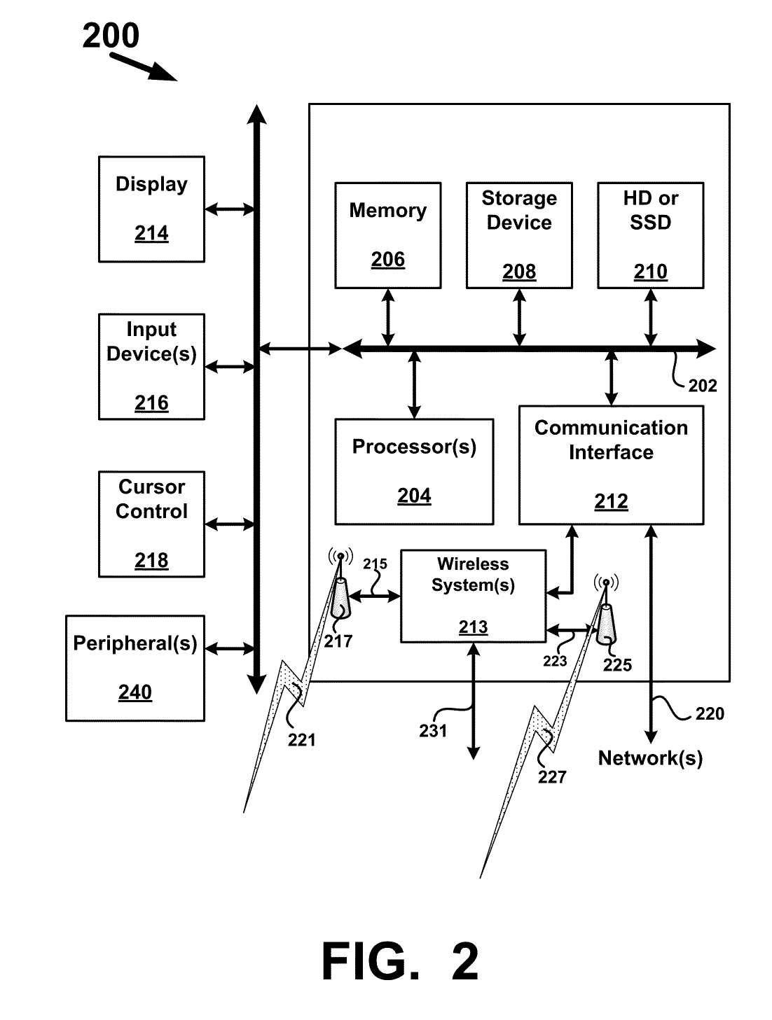

Turning now to FIG. 2 where one example of a computer system 200 suitable for use in the systems, methods, and apparatus described herein is depicted. In some examples, computer system 200 may be used to implement circuitry, hardware, client devices, media devices, computer programs, applications (e.g., APPs), application programming interfaces (APIs), configurations (e.g., CFGs), methods, processes, or other hardware and/or software to perform the above-described techniques (e.g., execution of one or more stages of flow 100). Computer system 200 may include a bus 202 or other communication mechanism for communicating information, which interconnects subsystems and devices, such as one or more processors 204, system memory 206 (e.g., RAM, SRAM, DRAM, Flash Memory), storage device 208 (e.g., Flash Memory, ROM), disk drive 210 (e.g., magnetic, optical, solid state), communication interface 212 (e.g., modem, Ethernet, one or more varieties of IEEE 802.11, WiFi, WiMAX, WiFi Direct, Bluetooth, Bluetooth Low Energy, NFC, Ad Hoc WiFi, HackRF, USB-powered software-defined radio (SDR), WAN or other), display 214 (e.g., CRT, LCD, OLED, touch screen), one or more input devices 216 (e.g., keyboard, stylus, touch screen display), cursor control 218 (e.g., mouse, trackball, stylus), one or more peripherals 240. Some of the elements depicted in computer system 200 may be optional, such as elements 214-218 and 240, for example and computer system 200 need not include all of the elements depicted. Computer system 200 may be networked (e.g., via wired and/or wireless communications link) with other computer systems (not shown).

According to some examples, computer system 200 performs specific operations by processor 204 executing one or more sequences of one or more instructions stored in system memory 206. Such instructions may be read into system memory 206 from another non-transitory computer readable medium, such as storage device 208 or disk drive 210 (e.g., a HD or SSD). In some examples, circuitry may be used in place of or in combination with software instructions for implementation. The term “non-transitory computer readable medium” refers to any tangible medium that participates in providing instructions and/or data to processor 204 for execution. Such a medium may take many forms, including but not limited to, non-volatile media and volatile media. Non-volatile media includes, for example, Flash Memory, optical, magnetic, or solid state disks, such as disk drive 210. Volatile media includes dynamic memory (e.g., DRAM), such as system memory 206. Common forms of non-transitory computer readable media includes, for example, floppy disk, flexible disk, hard disk, Flash Memory, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, wires that include bus 202 for transmitting a computer data signal. In some examples, execution of the sequences of instructions may be performed by a single computer system 200. According to some examples, two or more computer systems 200 coupled by communication link 220 (e.g., LAN, Ethernet, PSTN, wireless network, WiFi, WiMAX, Bluetooth (BT), NFC, Ad Hoc WiFi, HackRF, USB-powered software-defined radio (SDR), or other) may perform the sequence of instructions in coordination with one another. Computer system 200 may transmit and receive messages, data, and instructions, including programs, (e.g., application code), through communication link 220 and communication interface 212. Received program code may be executed by processor 204 as it is received, and/or stored in a drive unit 210 (e.g., a SSD or HD) or other non-volatile storage for later execution. Computer system 200 may optionally include one or more wireless systems 213 (e.g., one or more radios) in communication with the communication interface 212 and coupled (215, 223) with one or more antennas (217, 225) for receiving and/or transmitting RF signals (221, 227), such as from a WiFi network, BT radio, or other wireless network and/or wireless devices, for example. Examples of wireless devices include but are not limited to: a data capable strap band, wristband, wristwatch, digital watch, or wireless activity monitoring and reporting device; a smartphone; cellular phone; a tablet; a tablet computer; a pad device (e.g., an iPad); a touch screen device; a touch screen computer; a laptop computer; a personal computer; a server; a personal digital assistant (PDA); a portable gaming device; a mobile electronic device; and a wireless media device, just to name a few. Computer system 200 in part or whole may be used to implement one or more systems, devices, or methods that communicate with one or more external devices (e.g., external devices that transmit and/or receive electronic messages, such as Tweets). Wireless systems 213 may be coupled 231 with an external system, such as an external antenna or a router, for example. Computer system 200 in part or whole may be used to implement a remote server, a networked computer, a client device, a host device, a media device, or other compute engine in communication with other systems or devices as described herein. Computer system 200 in part or whole may be included in a portable device such as a smartphone, laptop, client device, host device, tablet, or pad.

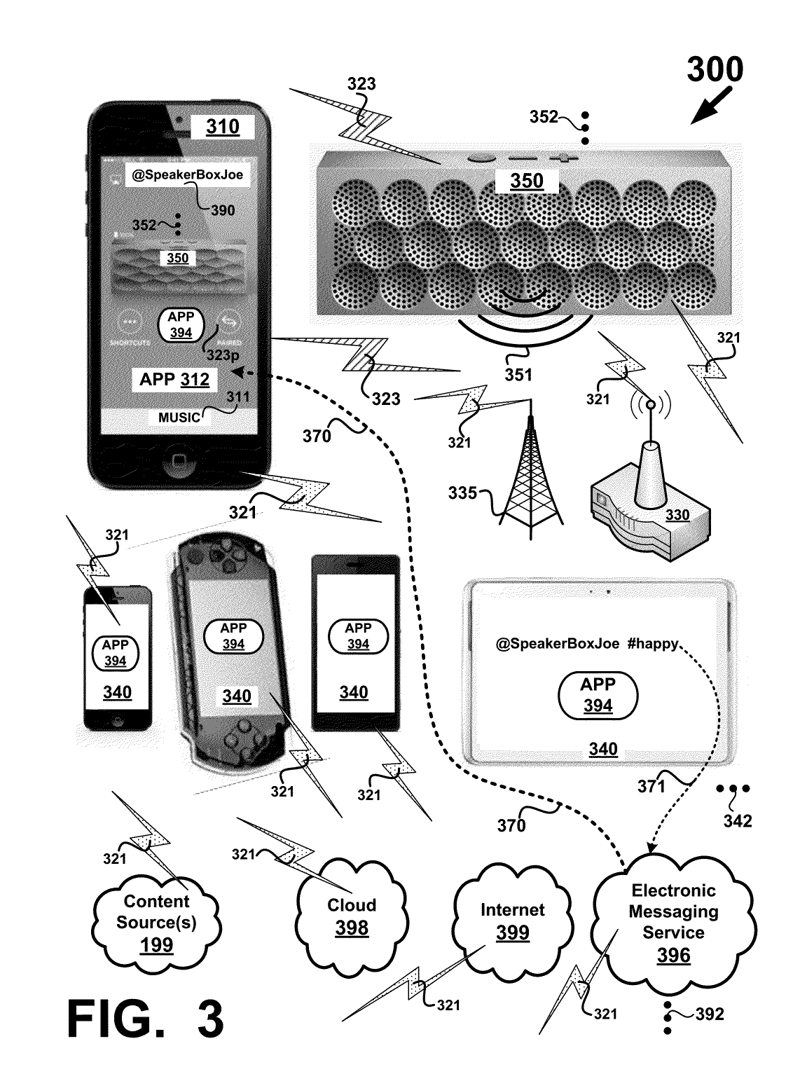

Moving on to FIG. 3 where one example of a system 300 to playback content using electronic messaging is depicted. In FIG. 3, a host device 310 may be in communication 323 (e.g., wireless communication) with at least one media device 350. Communication 323 between the host device 310 and the media device 350 may be via pairing 323p (e.g., BT pairing). Host device 310 and/or media device 350 may be in communication 321 with other communication networks such as wireless access point 330 (e.g., a WiFi router), a cellular communications tower 335, or other wireless systems. Although one media device 350 (e.g., a wirelessly enabled speaker box) is depicted, there may be additional media devices 350 as depicted by 352. Furthermore, host device 310 may be in communication (323, 321) with those additional media devices 350. Media device 350 may produce sound 351 from content being played back on the media device 350, for example. However, media device 350 may include other features and capabilities not depicted in the non-limiting example of FIG. 3, such as a display for presenting images, video, a GUI, a menu, and the like.

Host device 310 may execute an application APP 312 operative to monitor a communications network (e.g., via one or more radios in a RF system of 310) for an electronic message 371 that may be transmitted 321 by one or more client devices 340 to an electronic messaging service 396 which may process the message 371 and may subsequently transmit or otherwise broadcast the message to the host device as denoted by 370. Broadcast of electronic message 370 may be received by the host device (e.g., via APP 394) and may also be received by other devices that may have access to messages to the handle in message 370 (e.g., followers of “@SpeakerBoxJoe). The electronic message (e.g., a Tweet) may include an address that matches an address 390 (e.g., handle “@SpeakerBoxJoe) associated with host device 310 (e.g., an account, such as a Twitter account, registered to a user of host device 310). As described above in reference to FIG. 1 and flow 100, the electronic message may include a data payload (e.g., #happy) that may include information for the host device 310 to act on, such as a song title for music 311, a command for media device 350, or some other form of content, for example. APP 394 may be configured to operate with a single electronic messaging service 396 or may be configured to operate with one or more different electronic messaging services 396 as denoted by 392. The type and format of the electronic message 371 composed for each of the one or more different electronic messaging services 396 may be different and are not limited by the example electronic messages depicted herein.

Host device 310 and one or more client devices 340 (e.g., wireless devices of guests of a user of the host device 310) may both include an application APP 394 that may be used to compose electronic messages and to receive electronic messages that are properly addressed to the correct address for a recipient of the electronic message. Although several of the client devices 340 are depicted, there may be more or fewer client devices 340 as denoted by 342. An API or other algorithm in host device 310 may interface APP's 312 and 394 with each other such that the transmitted electronic message 370 is received by host device 310, passed or otherwise communicated to APP 394 which may communicate the electronic message 370 to APP 312 via the API. APP 312 may parse the electronic message 370 to determine if syntax of its various components (e.g., headers, packets, handle, data payload) are correct. Assuming for purposes of explanation the electronic message 370 is properly addressed and has valid syntax, the data payload may be acted on by APP 312 to perform an action indicated by the data payload. As one example, if the data payload includes “#happy”, APP 312 may pass (e.g., wirelessly communicate 321) the payload to content source(s) 199, Cloud 398, Internet 399 or some other entity where the data payload may be used as a search string to find content that matches “happy” (e.g., as a song title, an album title, movie title, etc.). As one example, communication 321 of a data equivalent of the text for “happy” to content source 199 (e.g., a music streaming service or music library) may cause the content source 199 to execute a search for content that matches “happy” in one or more data stores. A match or matches if found may be communicated 321 back to host device 310, media device 350 or both. In some examples, the data payload parsed by APP 312 may result in the data payload being communicated (321, 323) to the media device 350 and the media device 350 may pass the data equivalent of the text for “happy” to content source 199, where matches if found may be communicated 321 back to host device 310, media device 350 or both. In some examples, when a match is found for the search term (e.g., “happy”), media device 350 begins playback of the content (e.g., a digital audio file for “happy”) or queues the content for later playback using its various systems (e.g., DSP's, DAC's, amplifiers, etc.). In some examples, playback occurs by the media device 350 or the host device 310 streaming the content from content source(s) 199 or other sources (e.g., 398, 399), content that is queued for playback may be streamed when that content reaches the top of the queen. Each of the client devices 340 may compose (e.g., via APP 394) and communicate 321 an electronic message 371 addressed to handle “@SpeakerBoxJoe” with a content request “#content-title” and each request that is processed by APP 312 may be placed in a queue according to a queuing scheme (e.g., FIFO, LIFO, etc.).

In some examples, a search order for content to be acted on by media device 350 may include APP 312 searching for the content first in a data store of the host device 310 (e.g., in its internal data store such as Flash Memory or its removable data store such as a SD card or micro SD card), followed second in a data store of media device(s) 350 (e.g., in its internal data store such as Flash Memory or its removable data store such as a SD card or micro SD card), followed third by an external data store accessible by the host device 310, the media device 350 or both (e.g., NAS, a thumb drive, a SSD, a HDD, Cloud 398, Internet 399, etc.), and finally in content source(s) 199. In some examples, content that resides in an external source may be downloaded into a data store of the media device 350 or the host device 310 and subsequently played back on the media device 350. In other examples, the content may be streamed from the source it is located at.

Prior to receiving a first electronic message 317 requesting content to be played back, a user of host device 310 may activate the APP 312, may select an item of content for playback on media device 350, and may initiate playback of the selected content (e.g., MUSIC 311). Subsequent requests for playback of content via electronic messaging 370 may be acted on by host device 310 (e.g., via APP 312) by beginning playback of the content identified by the data payload or queuing it for later playback.

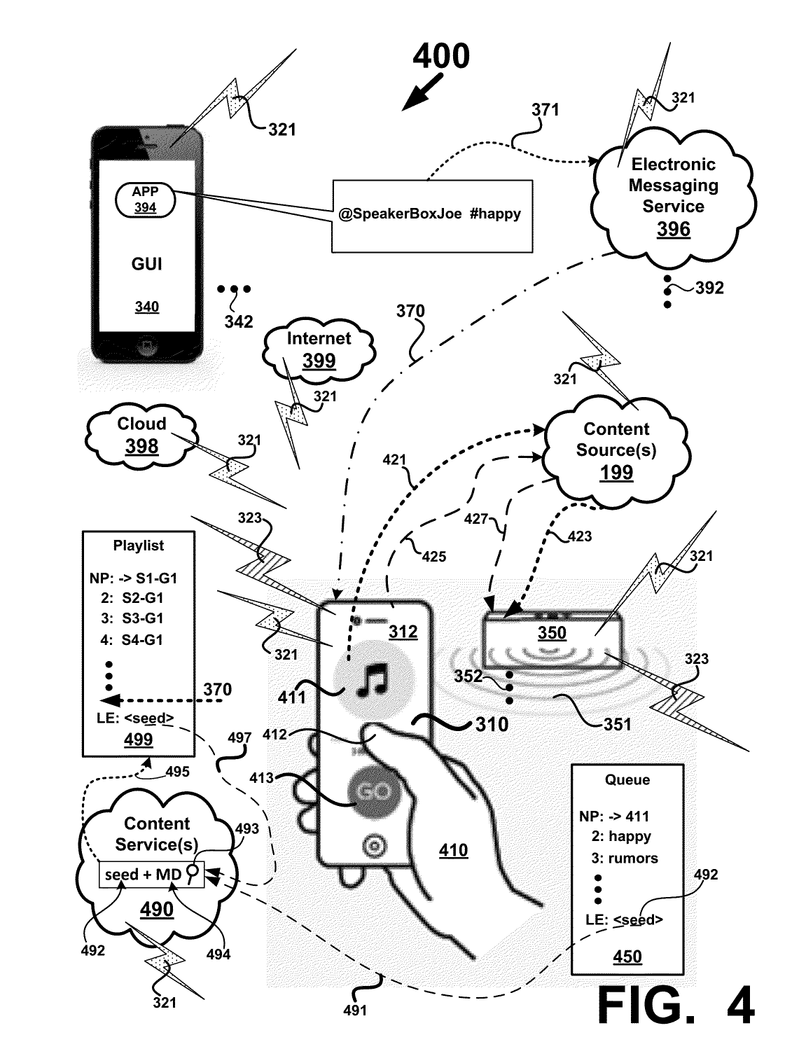

In FIG. 4 another example of a system 400 to playback content using electronic messaging is depicted. A user 410 of host device 310 may activate APP 312 and select (e.g., using thumb 412) a song 411 for playback on media device 350, and may initiate playback of song 411 by activating an icon or the like in a GUI of APP 312, such as a “GO” icon 413. Via an API or other computer executable program or algorithm, APP 312 may communicate 421 data for song 411 (e.g., via link 321) to content source 199 and the content source 199 may communicate 423 the content to media device 350 for playback as sound 351 generated by media device 350.

After initiation of playback on media device 350, song 411 may be a first song in a queue 450 as denoted by a now playing (NP) designation. Queue 450 may be displayed on a display system of host device 310, media device 350 or both. In some examples, queue 450 may be displayed on a display system of one or more client devices 340. In some examples, queue 450 may be displayed on a display system of one or more client devices 340 that have sent electronic messages 370 to host device 310.

Subsequently, a user of a client device 340 may compose an electronic message 371 that is received by electronic messaging service 396 and communicated to host device 310 as electronic message 370. A communication 421 for the song “happy” in the data payload of message 370 is transmitted 321 to content source 199 and accessed 427 for playback on media device 350. If song 411 is still being played back on media device 350, then the song “happy” may be placed in the queue 450 as the second song (e.g., the next song cued-up for playback) for media device 350 to playback after song 411 has ended or otherwise has its playback terminated. The song “rumors” may be placed third in queue 450 if it was the next request via electronic messaging after the request for “happy”, for example. The song “happy” may be the first song in the queue 450 (e.g., now playing) if the queue 450 was empty at the time “happy” was accessed 427 for playback on media device 350.

As additional user's compose messages addressed to “@SpeakerBoxJoe” on their respective client devices 340, song titles in their data payloads may be accessed from content source 199 and queued for playback on media device 350. As one or more songs are placed in queue 450, the queue may become a collaborative playlist used by the media device 350 to playback music or other content from friends, guests, associates, etc. of user 410, for example. The one or more songs or other content may be collaboratively queued starting from a first song (e.g., now playing NP:), a second song (e.g., “happy”), all the way to a last song in queue 450 denoted as last entry “LE:”.

In some examples, queue 450 may exhaust requests such that after the last entry “LE:” has been played back there are no more entries queued up. In order to prevent a lull in the playback of content (e.g., music at a party or social gathering), the last item of content in queue 450 may be operative as a seed for a playlist to be generated based on information that may be garnered from the user of host device 310, the media device 350, the host device 310 itself, one or more of the users of client devices 340, one or more of the client devices 340, or from data included in or associated with the content itself (e.g., metadata or the like).

In FIG. 4, assume for purposes of explanation that queue 450 is playing back its last entry “LE:” and no more electronic messages 370 have been received such that no new entries are being added to queue 450. APP 312 may, prior to or after completion of playback of the last entry “LE:” communicate 491 data for the last item of content to be played back, denoted as seed 492, to a content service(s) 490 that may perform a search 493 of a content data base (e.g., a library of content, such as music, videos, other digital media) for content from which to build a playlist 499 that may closely match some characteristic of seed 492. Additional data, such as metadata MD 494 may be included with and/or associated with seed 492 and may be used to better optimize results from search 493. Seed 492 and/or its MD 494 may be used to determine characteristics of the content that may be used to build the playlist 499. Characteristics that may be garnered from seed 492 and/or MD 494 include but are not limited to musical genre, playing time, artist or group name, album title, producer of the track, copyright date, art work, liner notes, leader(s), sidemen, etc., just to name a few, for example. Search 493 (e.g., via a search engine and/or other algorithms) may return results that may be used to populate 495 content in playlist 499. Playlist 499 may execute on media device 350 with each item cued into playlist 499 playing back in a queued order (e.g., FIFO or other). Search 493 may generate a finite list of items to populate 495 the playlist 499. If no new electronic messages 370 are received by host device 310 prior to playlist 499 reaching its last entry “LE:”, then content for the last entry “LE:” may be used as another seed 497 that is communicated (e.g., 321) to content service(s) 490 where another search 493 is performed using seed 497 and associated data (e.g., MD), if any, to generate another playlist that is populated with content for playback on media device 350. Content service(s) 490 may be different than content source(s) 199. Content service(s) 490 may be Cloud based, may be Internet based, may be a content streaming service or website, may be a music store, or other source of content, for example.

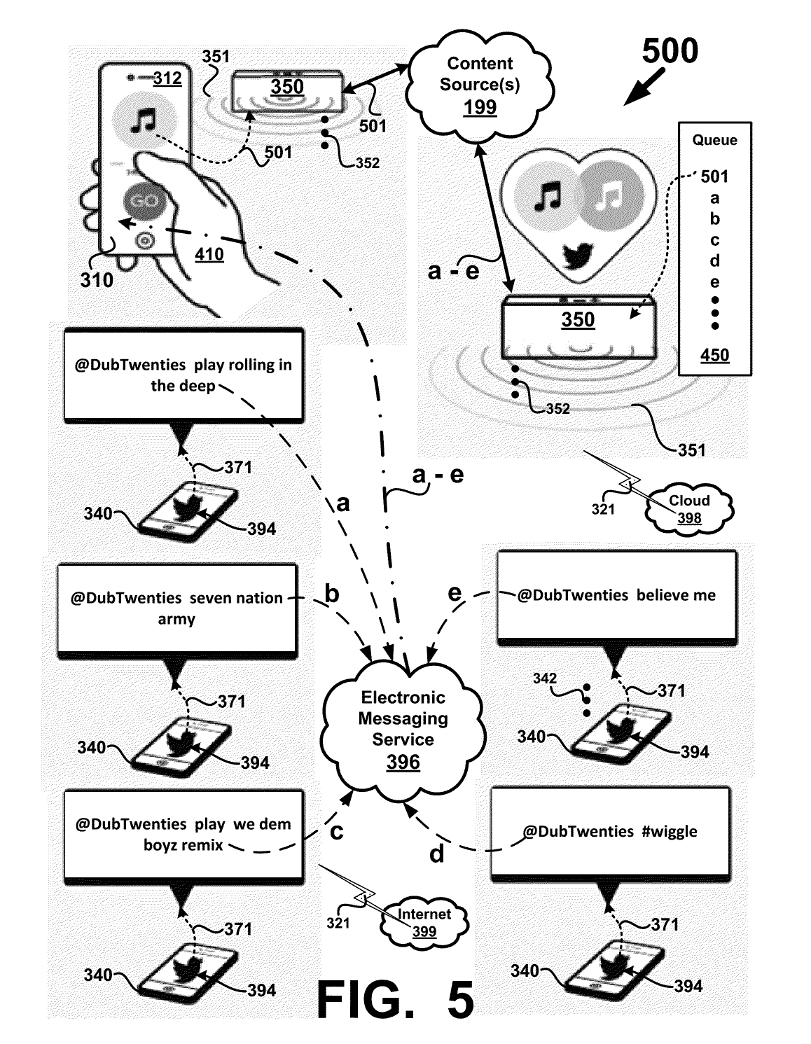

Reference is now made to FIG. 5 where yet another example of a system 500 to playback content using electronic messaging. In FIG. 5 a user 410 of host device 310 may have selected and initiated playback of content 501 on media device 350 and content 501 may be positioned first (e.g., now playing “NP:”) in queue 450. Subsequently, one or more users of client devices 340 may compose and transmit electronic messages a-e to a handle “@DubTwenties” associated with host device 310 and associated content request for data payloads of the electronic messages a-e as depicted. Parsing of the data payloads for electronic messages a-e may include allowing for variations in syntax that may occur due to different users composing electronic messages with different syntax for the data payload. Some users using the hash tag “#”, other users using one or more blank spaces “ ”, and yet other users using the keyword or command “play” proceeded by the content to be played. Those different forms of the data payload may include acceptable syntax and may be used in some examples to provide an easier interface between users and APP 312 executing on host device 310. Electronic messaging service 396 (e.g., Twitter or some other service) may process each of the electronic messages a-e and broadcast messages a-e to the handle “@DubTwenties” where they may be parsed, analyzed, and acted on as described above. For example, content 501 playing on media device 350 may be followed in queue 450 by song a, followed by b, c, d, and then e. In some examples, APP 312 may be configured to playback content in data payloads for electronic messages a-e in the order in which it received the electronic messages. In other examples, APP 312 may be configured to playback content in data payloads for electronic messages a-e in a random order (e.g., a shuffle play order).

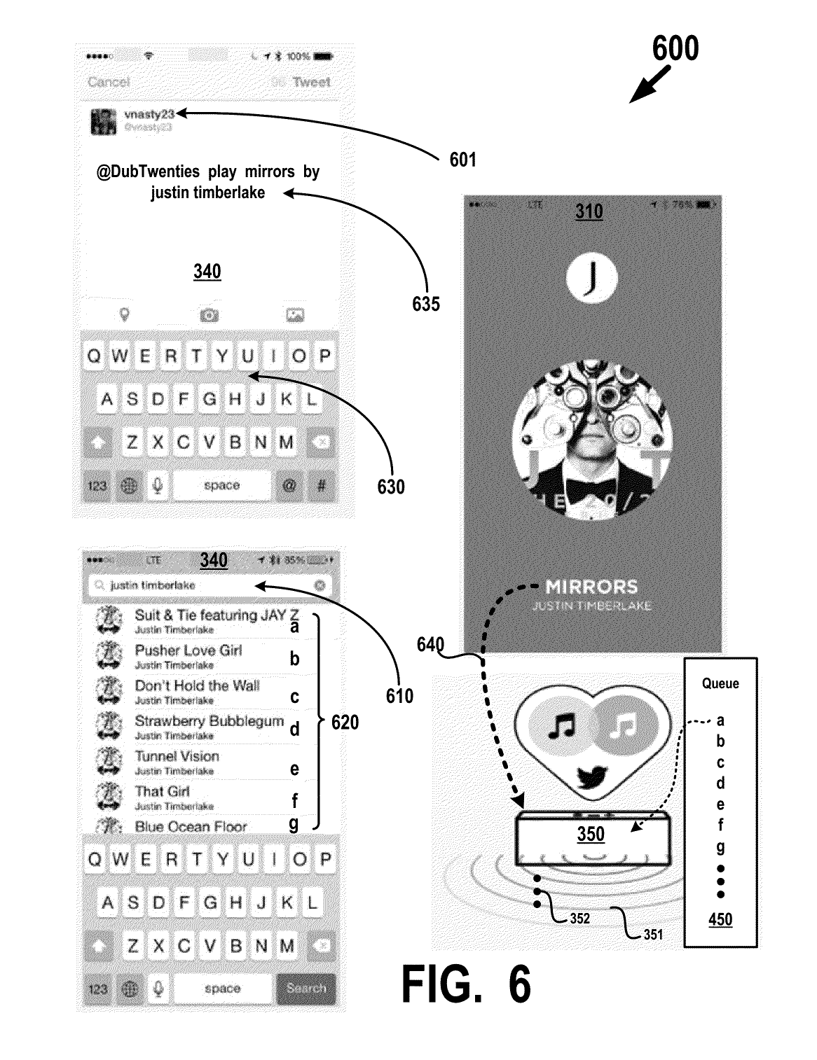

Turning now to FIG. 6 where an example 600 of playback of content using electronic messaging is depicted. In example 600, a user 601 of a client device 340 may perform a search 610 on client device 340 for music or other content from a specific artist, group, album, etc. Search results 620 returned from search 610 may yield one or more items of content. The user 601 may use information gleaned from the search results 620 to compose (e.g., using a touch screen keyboard 630) and electronic message 635 for handle “@DubTwenties” to “play mirrors by justin timberlake”, for example. Host device 310 and/or media device 350 may display images (e.g., cover art) of the “mirrors” album on a display device (e.g., a touch screen of host device 310). Content for songs a—g of the album may be communicated 640 to media device 350 for playback in some order, such as in queue 450 as depicted, for example. APP 312 may parse a data payload of a message, such as message 635 and may determine that the content may include an album of content (e.g., two or more songs) instead of a discrete item of content (e.g., a single song).

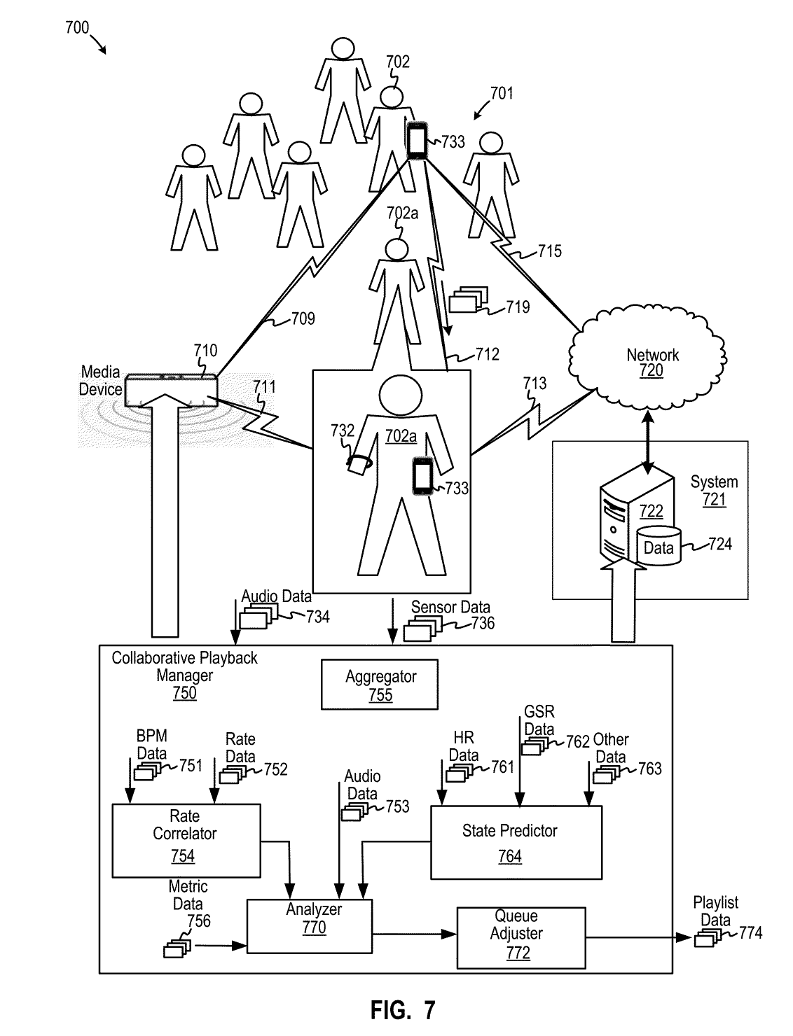

FIG. 7 is a diagram depicting an example of a collaborative playback manager, according to some embodiments. Diagram 700 depicts one or more groups 701 of individuals 702 that can receive audio (e.g., songs, sounds, etc.) from one or more media devices 710, the audio being presented based on a number of audio files including song data arranged in a collaboratively-formed playlist based on electronic messages and electronic message services, as described herein. According to various embodiments, collaborative playback manager 750 is configured to facilitate formation of collaborative playlists based on audio characteristics, such as beat-per-minute data, and/or state attributes derived from sensors among other structures and/or functions. Examples of state attributes include characteristics of an individual, such as individual 702, whereby the characteristics can describe physiological attributes (e.g., heart rate, GSR values, bioimpedance signal values, etc.), mood attributes (e.g., predicted affective states or moods, such as excited, stressed, depressed, angry, etc.), and motion attributes (e.g., rates in change of position or travel, number of steps per unit time, number of units of motion over unit time, such as dancing cadence or jumping rhythmically to the beat of a song, etc.), among others.

Individuals, such as individual 702a, can include wearable devices 732 (e.g., any type of wearable sensors, including UP™ by AliphCom of San Francisco, Calif.), a smart watch, a mobile computing device 733 (e.g., mobile phone, etc.), and the like. Mobile computing device 733 can include logic, including an application (e.g., APP) as described herein that is includes executable instructions to facilitate playback of content via collaboratively-built playlist. Wearable devices 732 can include any type of sensors, including heart rate sensors, GSR sensors, motion sensors, etc., as sources of state attribute values and/or data, to provide sensor data 736. Examples of suitable sensors are described in U.S. patent application Ser. No. 13/181,512 filed on Jul. 12, 2011.

As shown, wearable devices 732 and/or mobile computing device 733 can communicate audio data 734 and/or sensor data 736 (e.g., as a payload data) via communication links 709 and 711 with a media device 710 (e.g., a Jambox™ by AliphCom). Further, wearable devices 732 and/or mobile computing device 733 can communicate audio data 734 and/or sensor data 736 via communication links 713 and 715 through a network 720, such as the Internet, to a system 721. System 721 can represent any number of systems including server 722 and data repository 724. In some examples, system 721 represents one or more electronic messaging services or electronic streaming services, such as Twitter™ and Spotify™, whereby Twitter account data (or the like) can be stored in repository 724 and data representing music or audio tracks can be stored in repository 724. In other examples, system 721 can include a provider system that is configured to facilitate interactions among wearable devices 732, mobile computing devices 733 (e.g., including an application, such as a “drop” application or “Drop by Jawbone™”).

Collaborative playback manager 750 is shown to receive at least audio data 734, which can include data representing songs and related metadata, and sensor data 736 and is further configured to generate playlist data 774 representing a dynamic playlist that can adjust songs to be played based on audio characteristics, such as BPM, and state attributes (e.g., physiological characteristics, including heart rate, rate of motion, etc.). As shown, collaborative playback manager 750 includes an aggregator 755 configured to aggregate or otherwise generate data representing a collective audio characteristic value (e.g., a collective BPM, such as a median value, an average value, or a range of values) or a collective state attribute (e.g., a collective heart rate value, such as a median HR value, an average HR value, or a range of HR values) for subsets of individuals or any number or groupings of individuals 701. Collaborative playback manager 750 is configured to analyze, for example, a requested song to be “dropped” into a collaborative playlist relative to other songs in the playlist to determine whether the requested song is suitable for playback in a subset of songs queued to be played. For example, collaborative playback manager 750 is configured to ensure a slow tempo song or a classical song is not presented within a group of fast tempo songs or hip-hop songs.

Collaborative playback mentor 750 also includes a rate correlator 754, a state predictor 764, an analyzer 770, and a queue adjuster 772. Rate correlator 754 is configured to receive audio characteristic data, such as BPM data 751, and rate data 752, which can include one or more types of rate data based on audio data 734 or sensor data 736. For example, rate data 752 can represent an average BPM or a range of BPM values of a current playlist, or rate data 752 can represent an average heart rate value or a range of heart rate values. Further, rate data 752 can include data representing average motion or a range of motion values. Note that in some cases, an average motion or a range of motion values (or an average heart rate value or a range of heart rate values) may be a factor (e.g., a multiple or multiplicative inverse) of a BPM for a song. Rate correlator 754 is configured to match or correlate the audio characteristic value (e.g., a BPM value) relative to one or more aggregated representations of a representative BPM value for the playlist, of a representative heart rate value (or multiple/multiplicative inverse thereof) for individuals consuming the current play list, or of a representative value of motion (or multiple/multiplicative inverse thereof) or mood for individuals participating in the presentation of a collaborative playlist. Thus, rate correlator 754 can generate correlation data identifying, for example, amount of difference in BPM for a requested song and aggregated BPM values for the current playlist. The correlation data can be sent to analyzer 770, which is configured to analyze the correlation data, among other types of data, to govern the formation of an adjusted collaborative playlist.

State predictor 764 is configured to detect or determine a state of an individual 702 or a representative state of a group 701 of individuals. Examples of a state includes a physical state (e.g., whether one or more individuals are in motion or the relative degree of motion of that individuals, or whether the one or more individuals have similar heart rates as well as the values of such heart rates), and an affective state (e.g., a predicted state of emotion or mood for one or more individuals). Examples of relative degrees of motion can include values representing a number or proportion of individuals that are in motion (e.g., are dancing) relative to other individuals another, lesser degree of motion (e.g., other individuals are walking or congregating socially to converse with others). Examples of affective states include excited, content, sad, stressed, depressed, lethargic, energetic, etc., or values representing various numbers or proportions of one or more predicted affective states (e.g., 70% individuals are responding positively and energetically to a collaborative playlist relative to 305 who are associated with minimal motion). Further to diagram 700, state predictor 764 is configured to predict a state or states using heart rate data (“HR”) 761, a galvanic skin response data (“GSR”) 762, and/or other data 763 (e.g., sensor data 736, audio data 734, etc.).

In at least some embodiments, state predictor 764 can provide feedback as to the degree of responsiveness by individual 702 or group 701 of individuals to songs in a playlist. Should a degree of responsiveness be less than is desired or targeted, collaborative playback manager 750 and its components can adjust playlist data 774 to urge or influence an improvement of the degree of responsiveness. For example, if a pending playlist of several songs fails to encourage a sufficient number of individuals 702 to dance, collaborative playback manager 750 can adjust the playlist to solicit or otherwise encourage individuals to participate in dancing or other types of activities. Examples of one or more components, structures and/or functions of state predictor 764 or any other elements depicted in FIG. 7 may be implemented as described in U.S. patent application Ser. No. 13/831,301 filed on Mar. 14, 2013, Ser. No. 13/831,260 filed on Mar. 14, 2013, Ser. No. 13/802,305 filed on Mar. 13, 2013, and Ser. No. 13/802,319 filed on Mar. 13, 2013.

Analyzer 770 is shown to receive correlation data values from rate correlator 754 and state attribute values from state predictor 764, as well as audio data 753 and metric data 756. For example, analyzer 770 is configured to receive one or more values of rate correlation data (e.g., representing a degree of similarity or difference to collaborative playlist), one or more values of state attributes (e.g., representative state of motion, mood, or physiological conditions, such as heart rate). In some examples, audio data 753 includes metadata identifying an artist, a genre, an album, a requester identity, and the like for a song. Analyzer 770 can extract some metadata from a requested song and compare it against other metadata for songs in a playlist to determine a relative similarity or differences among one or more of the types of metadata for purposes of determining whether to adjust a playlist based on audio data 753.

Metric data 756 can include data that defines one or more operational modes of analyzer 770. For example, metric data 756 can specify a desired or targeted level of performance, such as the desirable range of BPMs for songs in a collaborative playlist or a desirable range of a number of individuals associated with a relatively high degree of motion (e.g., a number of individuals that are participating in dancing activities). Based on such metric data 756, analyzer 770 can cause queue adjuster 772 to adjust playlist data 774 to reach or otherwise encourage specific levels of performance. Further, metric data 756 can represent different weighting values to adjust a playlist to include more heavily weighted data values than other data values (e.g., weight BPM values greater than values indicative of a mood). Also, metric data 756 can define programmatic changes in levels of performance to achieve, for example, different sets of fast-paced songs interleaved with slow songs, thereby encouraging participants to rest or socialize. Metric data 756 can have other functions and are not limited to those described above.

Note that in accordance with various embodiments, individuals 702 can be co-located or can be dispersed geographically. As such, multiple media devices may be co-located with those dispersed individuals and need not be limited to a single geographic region. Further note that collaborative playback manager 750 need not be limited to disposition in a unitary device, but rather any of its components may be distributed among one or more of media devices 710, wearable devices 732, mobile computing devices 733, and systems 721. Note further, that communication link 712 can be established between computing devices 733 of users 702 and 702a in a peer-to-peer fashion to exchange sensor data 736 and audio data 732 as data 719. For example, user 702a and its computing device 733 may be implementing an application as a master control (e.g., as a “Master DJ” application. As such, user 702 may receive data 719 that includes a song or data representing a playlist (e.g., a personal playlist).

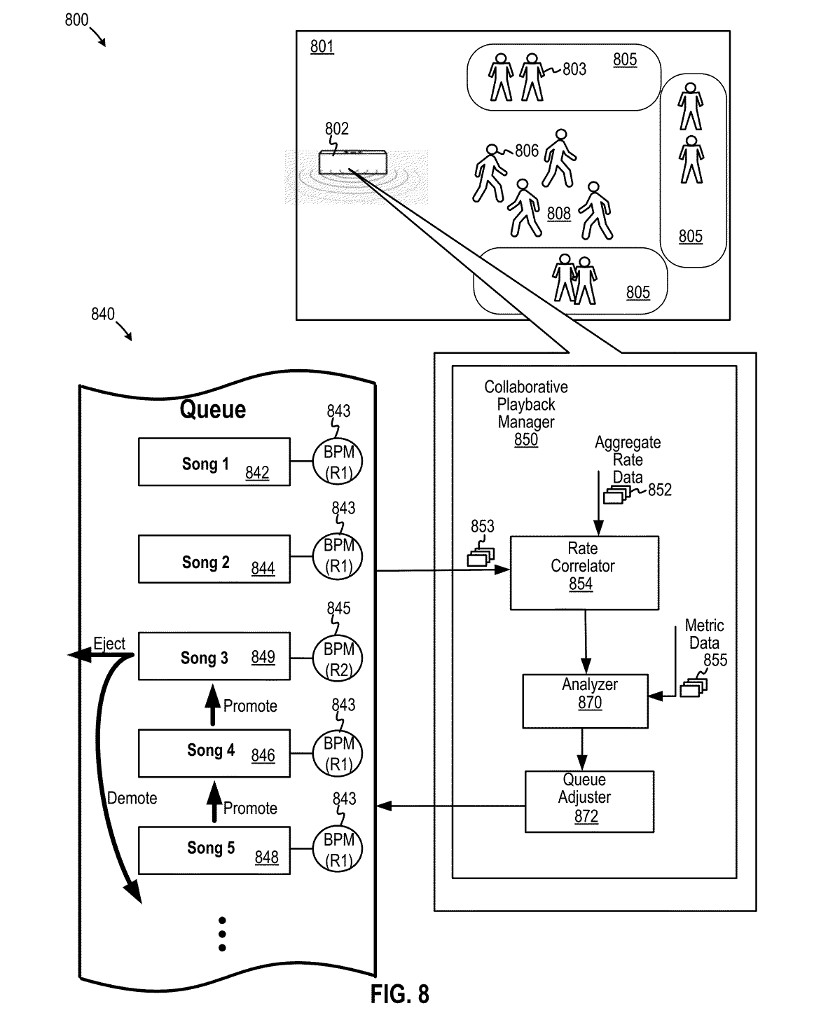

FIG. 8 is a diagram depicting one example of operation of a collaborative playback manager, according to some examples. Diagram 800 includes a collaborative playback manager 850 configured to manage adjustments to playback list or queue 840 as a function of beats-per-minute (“BPM”) values or ranges of values. Queue 804 is a data arrangement including data representing song (“1”) 842, song (“2”) 844, song (“3”) 849, song (“4”) 846, song (“5”) 848, among others, for presenting songs via media device 802 in region 801 (e.g., in a room, house, outdoors adjacent device 802, etc.) that includes individuals 806 and individuals 803. As shown, individuals 806 are associated with a sub-region 808, which can be a dance floor. Thus, in this example, individuals 806 are depicted as responding energetically to the playlist and its music selection. By contrast, individuals 803 associated with sub-regions 805, which are adjacent to a dance floor and make include, for example, a punch bowl or other beverages. Thus, individuals 803 are depicted as having relatively lower degrees of motion and/or heart rate, which may be a result of the current selection.

Collaborative playback manager 850 can be disposed in media device 802 or can be configured to communicate with media device 802. As shown, collaborative playback manager 850 includes a rate correlator 854, an analyzer 870, and a queue adjuster 872, which may have elements having structures and/or functions as similarly-named or similarly-numbered elements of FIG. 7. In some examples, rate correlator 854 is configured to receive data 853, which identifies a first value of BPM 843 associated with audio data for songs 842, 844, 846 and 848 and a second value of BPM 845 associated with audio data for song 849. Rate correlator 854 can generate correlation data indicating that second value of BPM 845 is more different (or less synchronous) than first value of BPM 843 is similar (or more synchronous) to target BPM values in metrics data 855 or aggregate rate data 852 (e.g., a representative heart rate or ranges of heart rate of individuals 806, or both groups of individuals 806 and 803). According to some examples, first value of BPM 843 may coincide with synchronicity of the dance movements for the songs being played, whereas the second value may be less likely to be synchronous with the dance movements. Analyzer 870 can generate data causing queue adjuster 872 to, for example, eject song 849 or demote it while promoting song 846 and song 848 in queue 840. Note that while in some embodiments, queue 840 can be disposed in a memory within media device 802. Or, queue 840 can be disposed in a mobile computing device (not shown) or system, whereby adjustments to a sequence of songs 842 to 849 can be made prior to transmission via electronic messages (e.g., before tweeting).

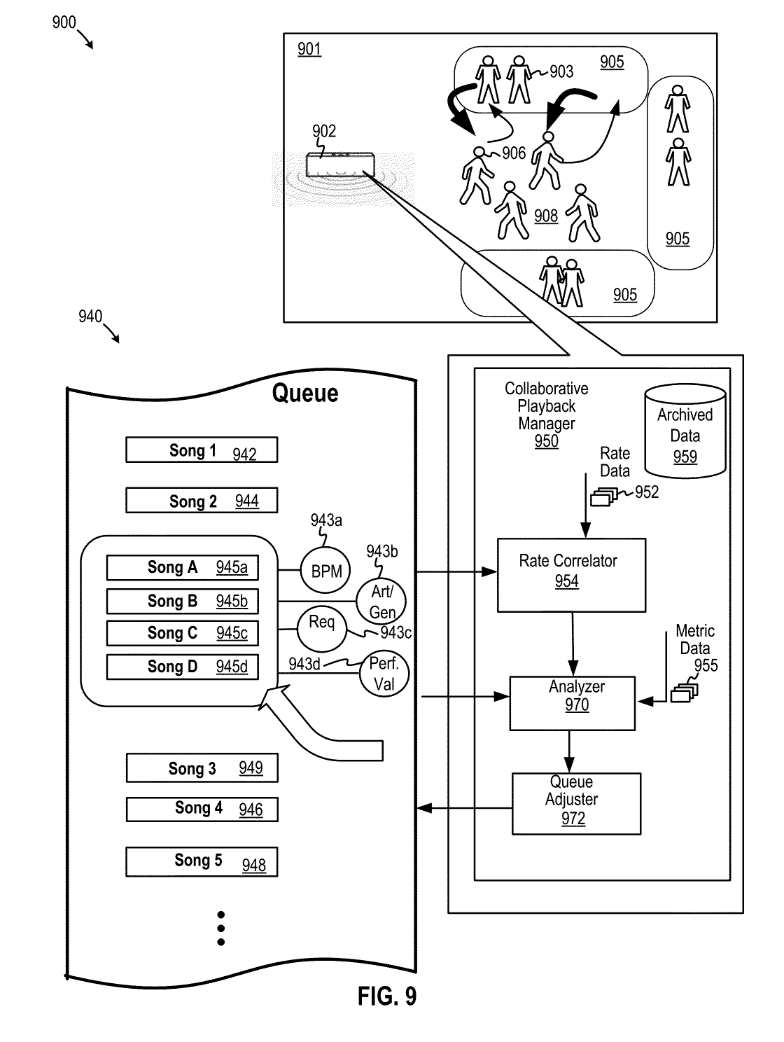

FIG. 9 is a diagram depicting another example of operation of a collaborative playback manager, according to some examples. Diagram 900 includes a collaborative playback manager 950 configured to manage adjustments to playback list or queue 940 as a function of data associated with songs in queue 940. Queue 904 is a data arrangement including data representing song (“1”) 942, song (“2”) 944, song (“3”) 949, song (“4”) 946, song (“5”) 948, among others, for presenting songs via media device 902 in region 901 that includes individuals 906 and individuals 903. As shown, individuals 906 are associated with a sub-region 908, which can be a dance floor. Thus, in this example, individuals 906 are depicted as responding energetically to the playlist and its music selection. By contrast, individuals 903 associated with sub-regions 905, which are adjacent to a dance floor, are depicted as having relatively lower degrees of motion and/or heart rate, which may be a result of the current selection.

Note further to example shown, the darker and heavier arrows exiting sub-regions 905 indicate a net increase in individuals 906 in sub-region 908. That is, more individuals 903 are shown to enter sub-region 908 to dance than the number of individuals 906 that exit sub-region 908 to stop participating. In some cases, specific audio tracks can elicit increased participation. As such, collaborative playback manager 950 can monitor (e.g., heart rate, motion data, etc.) for songs over a period of time to determine historically a specific value for performance (i.e., a performance value), which can be stored as archived data in repository 959.

Consider an example in which a number of individuals 903 that are not participating is greater than is desired or targeted. Collaborative playback manager 950 can receive as rate data 952, for example, a rate of participation that is below a target level. In some cases, the rate of participation can be based on an average heart rate or an average of motion rate that is below an average targeted heart rate or average targeted motion rate. As shown, collaborative playback manager 950 includes a rate correlator 954, an analyzer 970, and a queue adjuster 972, which may have elements having structures and/or functions as similarly-named or similarly-numbered elements of FIG. 7 or elsewhere herein. Rate correlator 954 is configured to determine correlation data that describes a correlation between the songs 942 to 948 in queue 940 relative to the rate data 952. Analyzer 970 is configured to receive metric data 955 that can include a target performance level that is higher than the performance level specified by rate data 952. For example, if a target performance level is set to encourage 60% of individuals to participate in dancing, then analyzer 950 can be configured to cause queue adjuster 972 to adjust queue 940 to urge increases in the participation rates.

To illustrate an adjustment to the playlist, consider that collaborative playback manager 950 searches archived data 959 to determine data representing values or ranges of values of beats-per-minute (“BPM”) 943a (as well as historic or past BPM data associated with a song), data representing popular artists or genre (“Art/Gen”) 943b, an identity of a requester (“Req”) 943c (e.g., a requester that typically requests songs resulting in high participation rates), and a performance value (“Perf. Val”) 943d that describes a representative historic or past performance value relative to a target value. For example, a song may be associated with a performance value 943d that historically has coincided with a 70% participation rate. Thus, the selection of that song may encourage participation. Next, consider that the results of searching the above-described data in archived data 959 yields results that include song (“A”) 945b to song (“D”) 945d for data 943a to 943d. Therefore, collaborative playback manager 950 can introduce song (“A”) 945b to song (“D”) 945d into queue 940 to encourage an increased number of individuals 903 to participate.

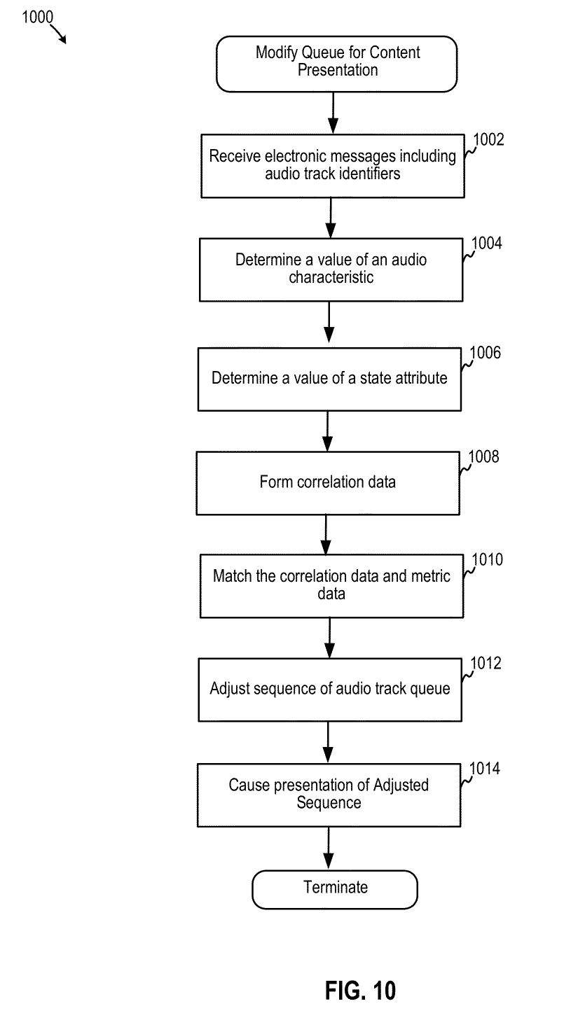

FIG. 10 is an example of a flow diagram to modify a sequence of content stored in a queue of content to adjust a collaborative playlist, according to some embodiments. FIG. 10 depicts a flow 1000 that begins at 1002 whereby electronic messages that can include identifiers, such as text-based titles, to identify audio tracks are received. In some cases, the electronic messages are asynchronous and are configured to be directed to a data arrangement constituting an account (e.g., an electronic messaging account, such as a Twitter™ account or handle) of an electronic messaging service including a server and a memory to store the account.

At 1004, a first subset of data representing a value of an audio characteristic can be determined. In some cases, values of the audio characteristic can include a number of beats-per-minute for one or more audio tracks. At 1006, a second subset of data representing a value of a state attribute can be determined. In various examples, state attribute values can include or represent motion data, mood data, heart rate data, or any other state attribute based on data generated by sensors.

At 1008, correlation data is formed to specify a degree of correlation between, for example, a value of an audio characteristic and a value of the state attribute (e.g., a heart rate, a number of participants engaged in dancing, etc.). At 1010, the correlation data can be matched against metric data to identify a position for playback of an audio track relative to other audio tracks. For example, the position for playback can be determined by promoting a song closer to playback, demoting a song further back (in time) in a queue, ejecting a song, or the like. At 1012, a sequence in which the audio tracks are to be presented from a data arrangement can be adjusted. At 1014, presentation of the adjusted sequence of the audio tracks can be initiated.

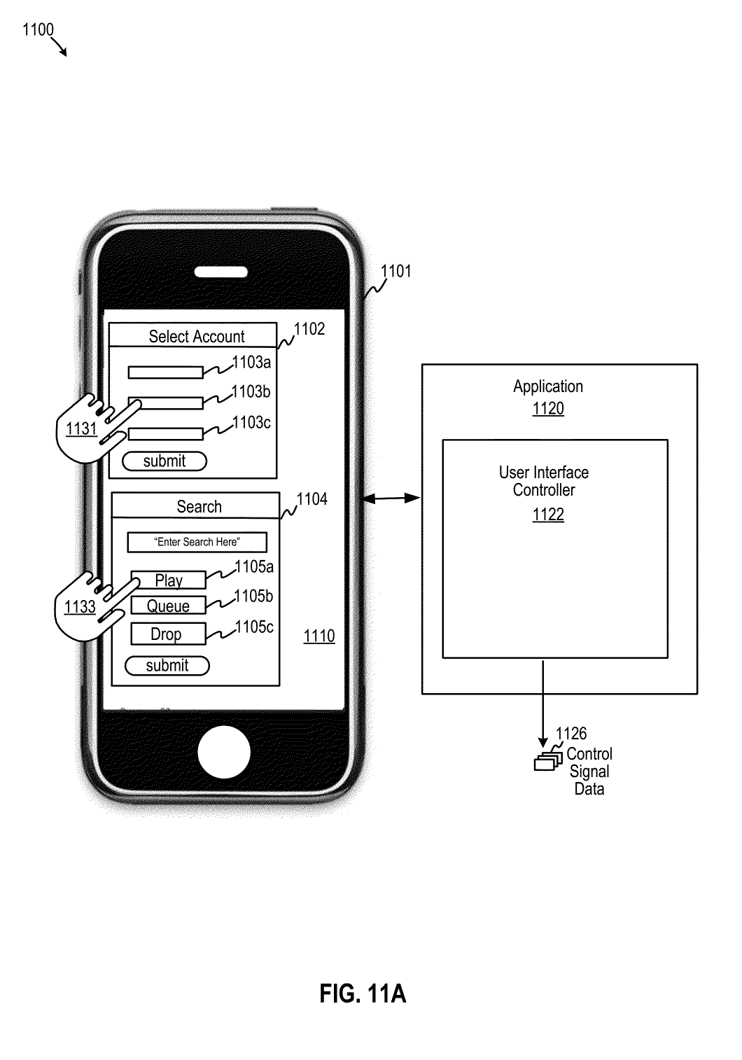

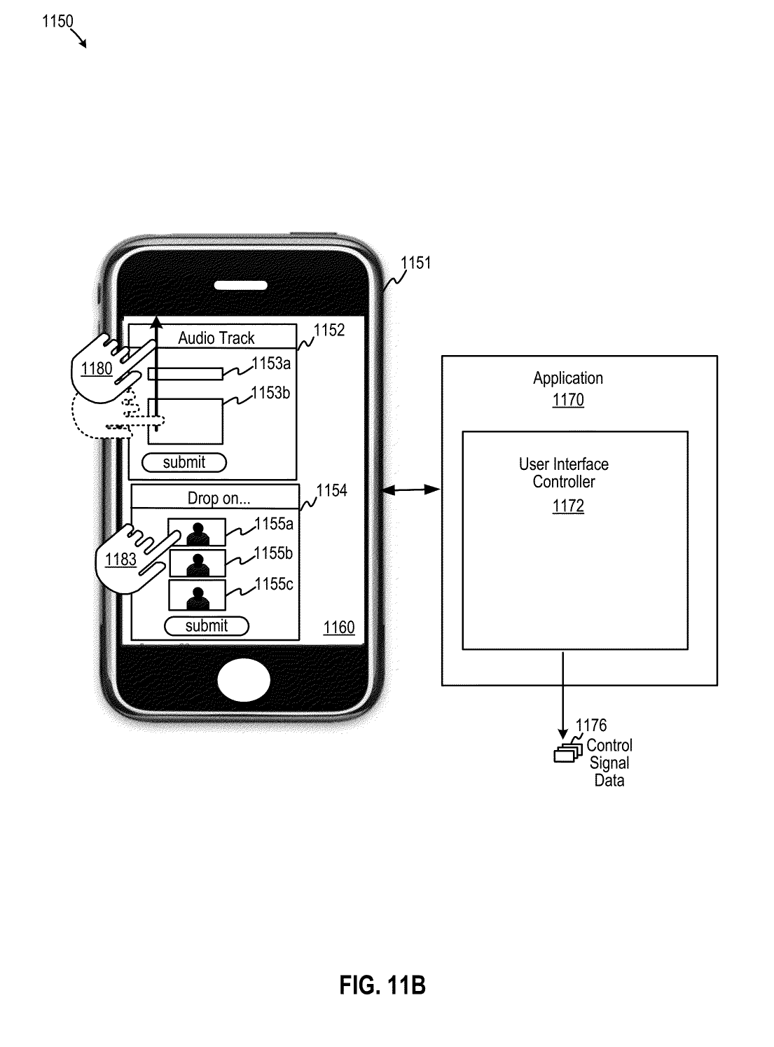

FIGS. 11A and 11B are diagrams depicting implementation of a user interface controller, according to various embodiments. Diagram 1100 of FIG. 11A depicts a mobile computing device 1101 having a user interface 1110, whereby an application 1120 including a user interface controller 1122 can be stored in a memory in mobile computing device 1101. An example of application 1120 including executable instructions to cause a song to “drop” via an electronic messaging system into a collaborative playlist as described herein. According to some examples, user interface controller 1122 is configured to present a portion 1102 of user interface 1110, which can be touch-sensitive, that is configured to generate signals to select an account to which electronic messages (e.g., “tweets”) are to be sent to add songs to a playlist. In some cases, input portions 1103a to 1103c each select a unique destination (e.g., a unique account associated with a specific media device). As shown, a user 1131 selecting input portion 1103c can cause application 1120 to direct song requests (e.g., as control signal data 1126) to an electronic messaging account for playback of content. As another example, user interface controller 1122 is configured to present a touch-sensitive portion 1104 of user interface 1110, which is configured to generate signals to search for a title of a song. Upon identifying a song from a search, user 1133 can cause portion 1105a to generate a control signal to “play” the selected song by causing application 1120 to direct the requested song (e.g., as control signal data 1126) to the selected electronic messaging account (associated with portion 1103b) for playback of content. User interface controller 1122 is also configured to present in touch-sensitive portion 1104 an input portion 1105b to activate queuing of song and an input portion 1105c to activate dropping of song via electronic messaging to, for example, another electronic messaging account associated with a friend.

Diagram 1150 of FIG. 11B depicts a mobile computing device 1151 having a user interface 1160, whereby an application 1170 including a user interface controller 1172 can be stored in a memory in mobile computing device 1151. Similarly-named applications and user interface controllers are describe in FIG. 11A, among other places. Application 1170 includes executable instructions to cause a song to “drop” via an electronic messaging system into a collaborative playlist as described herein. According to some examples, user interface controller 1172 is configured to present a portion 1152 of user interface 1160, which can be touch-sensitive, that is configured to generate signals to cause electronic messages to include a command to skip a play selection (e.g., a song currently being played in a playlist) responsive to user 1180 selecting input portion 1153b and performing, for example, an upward swiping gesture. User interface controller 1172 is configured to detect the upward swiping gesture and generate an electronic message (e.g., a “tweet”) as control signal data 1176.

Further, portion 1152 can include a portion 1153a, when selected, is configured to cause generation of a signal to be received by user interface controller 1172. In turn, user interface controller 1172 is configured to detect a request to “drop” or send a song (or data representing a song or a pointer thereto) to one or more other electronic message accounts (e.g., associated with other “Twitter™” handles or accounts). Responsive to detecting such a request, user interface controller 1172 is configured to generate a portion 1154 of user interface 1160 to present a number of selectable icons 1155a to 1155c that when selected can cause application 1170 to transmit an electronic message as control signal data 1176 via an electronic messaging system. As shown, user 1183 selects icon 1155a, which identifies an account of a friend to which a song can be transmitted, according to various embodiments.

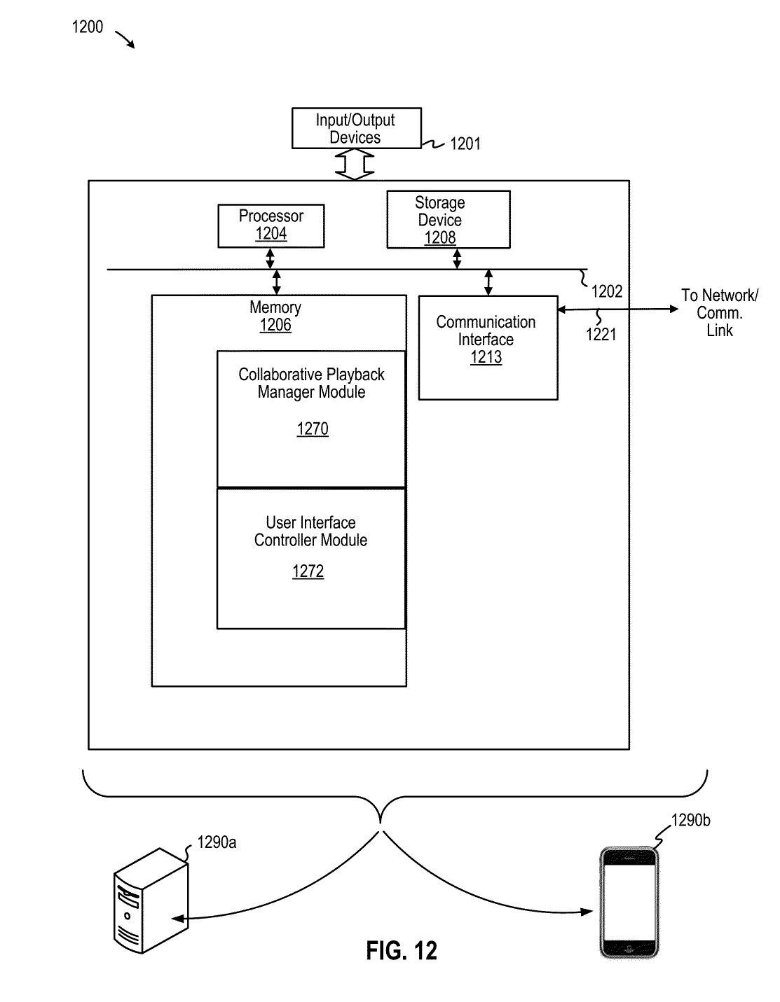

FIG. 12 illustrates an exemplary computing platform disposed in a device configured to adjust collaborative playlists via electronic messaging in accordance with various embodiments. In some examples, computing platform 1200 may be used to implement computer programs, applications, methods, processes, algorithms, or other software to perform the above-described techniques.

In some cases, computing platform can be disposed in wearable device or implement, a mobile computing device 1290b, or any other device, such as a computing device 1290a.

Computing platform 1200 includes a bus 1202 or other communication mechanism for communicating information, which interconnects subsystems and devices, such as processor 1204, system memory 1206 (e.g., RAM, etc.), storage device 12012 (e.g., ROM, etc.), a communication interface 1213 (e.g., an Ethernet or wireless controller, a Bluetooth controller, etc.) to facilitate communications via a port on communication link 1221 to communicate, for example, with a computing device, including mobile computing and/or communication devices with processors. Processor 1204 can be implemented with one or more central processing units (“CPUs”), such as those manufactured by Intel® Corporation, or one or more virtual processors, as well as any combination of CPUs and virtual processors. Computing platform 1200 exchanges data representing inputs and outputs via input-and-output devices 1201, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 1200 performs specific operations by processor 1204 executing one or more sequences of one or more instructions stored in system memory 1206, and computing platform 1200 can be implemented in a client-server arrangement, peer-to-peer arrangement, or as any mobile computing device, including smart phones and the like. Such instructions or data may be read into system memory 1206 from another computer readable medium, such as storage device 1208. In some examples, hard-wired circuitry may be used in place of or in combination with software instructions for implementation. Instructions may be embedded in software or firmware. The term “computer readable medium” refers to any tangible medium that participates in providing instructions to processor 1204 for execution. Such a medium may take many forms, including but not limited to, non-volatile media and volatile media. Non-volatile media includes, for example, optical or magnetic disks and the like. Volatile media includes dynamic memory, such as system memory 1206.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1202 for transmitting a computer data signal.

In some examples, execution of the sequences of instructions may be performed by computing platform 1200. According to some examples, computing platform 1200 can be coupled by communication link 1221 (e.g., a wired network, such as LAN, PSTN, or any wireless network) to any other processor to perform the sequence of instructions in coordination with (or asynchronous to) one another. Computing platform 1200 may transmit and receive messages, data, and instructions, including program code (e.g., application code) through communication link 1221 and communication interface 1213. Received program code may be executed by processor 1204 as it is received, and/or stored in memory 1206 or other non-volatile storage for later execution.

In the example shown, system memory 1206 can include various modules that include executable instructions to implement functionalities described herein. In the example shown, system memory 1206 includes a collaborative playback manager module 1270 and a user interface controller module 1272, one or more of which can be configured to provide or consume outputs to implement one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, a collaborative playback manager or one or more of its components (or a dynamic meal plan manager or a consumable item selection predictor), or any process or device described herein, can be in communication (e.g., wired or wirelessly) with a mobile device, such as a mobile phone or computing device, or can be disposed therein.

In some cases, a mobile device, or any networked computing device (not shown) in communication with a collaborative playback manager or one or more of its components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figure can represent one or more algorithms. Or, at least one of the elements can represent a portion of logic including a portion of hardware configured to provide constituent structures and/or functionalities.

For example, a collaborative playback manager, or, any of its one or more components, or any process or device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

For example, a collaborative playback manager, including one or more components, or any process or device described herein, can be implemented in one or more computing devices that include one or more circuits. Thus, at least one of the elements in the above-described figures can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described techniques or the present application. The disclosed examples are illustrative and not restrictive.

What is claimed:

1. A method, comprising:
receiving a plurality of electronic messages including identifiers identifying audio tracks;
determining a first subset of data representing a value of an audio characteristic;
determining a second subset of data representing a value of a state attribute;
correlating the value of the audio characteristic and the value of the state attribute to form correlation data;
matching at a processor the correlation data against metric data to identify a position for playback of an audio track relative to other audio tracks;
adjusting a sequence in which the audio tracks are to be presented from a data arrangement representing a queue in accordance with an adjusted sequence; and
causing the adjusted sequence of the audio tracks to be presented.

2. The method of claim 1, wherein the determining the first subset of data representing the value of the audio characteristic comprises:
determining a first subset of rate data representing a number of beats-per-minute for the audio tracks.

3. The method of claim 1, wherein determining the second subset of data representing the value of the state attribute comprises:
determining the value of the state attribute associated with a plurality of sources of the state attribute.

4. The method of claim 3, wherein determining the value of the state attribute associated with the plurality of sources of the state attribute comprises:
determining heart rate data based on a plurality of sensors.

5. The method of claim 3, wherein determining the value of the state attribute associated with the plurality of sources of the state attribute comprises:
determining mood data based on a plurality of sensors.

6. The method of claim 3, wherein determining the value of the state attribute associated with the plurality of sources of the state attribute comprises:
determining motion data based on a plurality of sensors.

7. The method of claim 1, wherein receiving the plurality of electronic messages comprises:
receiving the plurality of electronic messages configured to be directed to a device including a data arrangement constituting an account.

8. The method of claim 7, wherein receiving the plurality of electronic messages comprises:
receiving a plurality of asynchronous electronic messages configured to be directed to a data arrangement constituting an account of an electronic messaging service including a server and a memory to store the account.

9. An apparatus comprising:
one or more processors coupled to memory configured to:
receive a plurality of electronic messages including identifiers identifying audio tracks;
determine a first subset of data representing a value of an audio characteristic;
determine a second subset of data representing a value of a state attribute;
correlate the value of the audio characteristic and the value of the state attribute to form correlation data;
match at a processor the correlation data against metric data to identify a position for playback of an audio track relative to other audio tracks;
adjust a sequence in which the audio tracks are to be presented from a data arrangement representing a queue in accordance with an adjusted sequence; and
cause the adjusted sequence of the audio tracks to be presented.

10. The apparatus of claim 8, wherein the one or more processors configured to determine the first subset of data representing the value of the audio characteristic are further configured to:
determine a first subset of rate data representing a number of beats-per-minute for the audio tracks.

11. The apparatus of claim 9, wherein the one or more processors configured to determine the second subset of data representing the value of the state attribute are further configured to:
determine the value of the state attribute associated with a plurality of sources of the state attribute.

12. The apparatus of claim 11, wherein the one or more processors configured to determine the value of the state attribute associated with the plurality of sources of the state attribute are further configured to:
determine heart rate data based on a plurality of sensors.

13. The apparatus of claim 11, wherein the one or more processors configured to determine the value of the state attribute associated with the plurality of sources of the state attribute are further configured to:
determine mood data based on a plurality of sensors.

14. The apparatus of claim 11, wherein the one or more processors configured to determine the value of the state attribute associated with the plurality of sources of the state attribute are further configured to:
determine motion data based on a plurality of sensors.

15. The apparatus of claim 9, wherein the one or more processors configured to receive the plurality of electronic messages are further configured to:
receive the plurality of electronic messages configured to be directed to a device including a data arrangement constituting an account.

16. The apparatus of claim 15, wherein the one or more processors configured to receive the plurality of electronic messages are further configured to:
receive a plurality of asynchronous electronic messages configured to be directed to a data arrangement constituting an account of an electronic messaging service including a server and a memory to store the account.
